(19) United States
(12) Patent Application Publication
(10) Pub. No.: US 2015/0147429 A1
(43) Pub. Date: May 28, 2015

(54) MOLD FOR FORMING LENS

(71) Applicant: SAMSUNG ELECTRO-MECHANICS CO., LTD., Gyeonggi-do (KR)

(72) Inventors: Yang Ho MOON, Gyeonggi-Do (KR); Ki Bok KWON, Gyeonggi-Do (KR); Yong Jin KIM, Gyeonggi-Do (KR)

(73) Assignee: SAMSUNG ELECTRO-MECHANICS CO., LTD., Gyeonggi-Do (KR)

(21) Appl. No.: 14/249,971

(22) Filed: Apr. 10, 2014

(30) Foreign Application Priority Data
Nov. 25, 2013 (KR) 10-2013-0143921

(51) Int. Cl. B29C 33/38; B29D 11/00

(52) U.S. Cl. CPC B29C 33/3828; B29D 11/005
USPC 425/468

(57) ABSTRACT

Embodiments of the invention provide a mold for forming a lens including a first core coupled with a first core hole of a first mold, and a second core coupled with a second core hole of a second mold to face the first core. In accordance with at least one embodiment, the first core and the second core are made of a material having a coefficient of thermal expansion larger than that of the first mold and the second mold, and outer diameters of the first core and the second core are each formed to be smaller than diameters of the first core hole and the second core hole.

### CROSS REFERENCE TO RELATED APPLICATION

This application claims the benefit of and priority under 35 U.S.C. §119 to Korean Patent Application No. KR 10-2013-0143921, entitled “Mold for Forming Lens,” filed on Nov. 25, 2013, which is hereby incorporated by reference in its entirety into this application.

### BACKGROUND

1. Field of the Invention

The present invention relates to a mold for forming a lens.

2. Description of the Related Art

The maintenance of an appearance, physical properties, and dimension precision, which are three factors of a product greatly depends on a temperature structure and a structure of a mold, as generally identified in conventional art, for example, Japanese Patent No. 5112633. The greatest problem at the time of molding a camera lens is a decenter that a center between a moving mold and a fixing mold is mismatched.

The problem is fatal in optical performance of a final lens product.

### SUMMARY

Accordingly, embodiments of the present invention provide a mold for forming a lens capable of preventing a decenter from occurring between mutually facing cores of the mold.

According to a preferred embodiment of the present invention, there is provided a mold for forming a lens, the mold including a first core coupled with a first core hole of a first mold, and a second core coupled with a second core hole of a second mold to face the first core. In accordance with at least one embodiment, the first core and the second core are each made of a material having a coefficient of thermal expansion larger than that of the first mold and the second mold, and outer diameters of the first core and the second core are each formed to be smaller than diameters of the first core hole and the second core hole.

In accordance with at least one embodiment, the outer diameters of the first core and the second core are each formed to be 1 to 2 μm smaller than diameters of the first core hole and the second core hole.

In accordance with at least one embodiment, when an expansion of the first core is ΔP₁ and an expansion of the first core hole is ΔH₁, a conditional equation of 2 μm<ΔP₁−ΔH₁ is satisfied.

In accordance with at least one embodiment, when an expansion of the second core is ΔP₂ and an expansion of the second core hole is ΔH₂, a conditional equation of 2 μm<ΔP₂−ΔH₂ is satisfied.

In accordance with at least one embodiment, the first core or the second core is made of a material having a coefficient of thermal expansion of 17×10⁻⁶ or more.

In accordance with at least one embodiment, when the coefficient of thermal expansion of the first core is α₁ and the coefficient of thermal expansion of the first mold is β₁, the conditional equation of 5×10⁻⁶<α₁−β₁<10×10⁻⁶ is be satisfied.

In accordance with at least one embodiment, when the coefficient of thermal expansion of the second core is α₂ and the coefficient of thermal expansion of the second mold is β₂, a conditional equation of 5×10⁻⁶<α₂−β₂<10×10⁻⁶ is satisfied.

In accordance with at least one embodiment, the first core and the second core are made of a material having heat conductivity of 50 W/m ° C. or more.

In accordance with at least one embodiment, the first core and the second core are made of a moldmax material.

In accordance with at least one embodiment, outer surfaces of the first core and the second core are plated with nickel (Ni).

According to another preferred embodiment of the present invention, there is provided a mold for forming a lens, the mold including a first mold formed with a first core hole, a second mold disposed in a direction in which the second mold faces the first mold and formed with a second core hole, a first core coupled with the first core hole of the first mold, and a second core coupled with the second core hole of the second mold to face the first core. In accordance with at least one embodiment, the first core and the second core are made of a material having heat conductivity of 50 W/m ° C. or more.

In accordance with at least one embodiment, the first core and the second core are each made of a material having a coefficient of thermal expansion larger than that of the first mold and the second mold, and an outer diameter of the first core and the second core are formed to be smaller than a diameter of the first core hole and the second core hole.

In accordance with at least one embodiment, the outer diameters of the first core and the second core are each formed to be 1 to 2 μm smaller than diameters of the first core hole and the second core hole.

In accordance with at least one embodiment, when expansion of the first core is AP and an expansion of the first core hole is ΔH₁, a conditional equation of 2 μm<ΔP₁−ΔH₁ is satisfied.

In accordance with at least one embodiment, when an expansion of the second core is ΔP₂ and an expansion of the second core hole is ΔH₂, a conditional equation of 2 μm<ΔP₂−ΔH₂ is satisfied.

In accordance with at least one embodiment, the first core and the second core are made of a material having a coefficient of thermal expansion of 17×10⁻⁶ or more.

In accordance with at least one embodiment, when the coefficient of thermal expansion of the first core is α₁ and the coefficient of thermal expansion of the first mold is β₁, the conditional equation of 5×10⁻⁶<α₁−β₁<10×10⁻⁶ is satisfied.

In accordance with at least one embodiment, when the coefficient of thermal expansion of the second core is α₂ and the coefficient of thermal expansion of the second mold is β₂, a conditional equation of 5×10⁻⁶<α₂−β₂<10×10⁻⁶ is satisfied.

In accordance with at least one embodiment, the first core and the second core are made of a moldmax material.

In accordance with at least one embodiment, outer surfaces of the first core and the second core are plated with nickel (Ni).

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a schematic diagram illustrating a mold for forming a lens, in accordance with an embodiment of the present invention.

FIG. 2 is a schematic diagram illustrating a main part of the mold for forming a lens, in accordance with an embodiment of the present invention.

FIG. 3 is a schematic diagram illustrating a state in which a first mold and a second mold are spaced apart from each other in the mold for forming a lens, in accordance with an embodiment of the present invention.

FIG. 4 is a graph illustrating an aspheric shape error of one surface of the lens formed in the mold for forming a lens, in accordance with an embodiment of the present invention, and the mold for forming a lens, in accordance with the conventional art.

FIG. 5 is a graph illustrating an aspheric shape error of the other surface of the lens formed in the mold for forming a lens, in accordance with an embodiment of the present invention, and the mold for forming a lens, in accordance with the conventional art.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

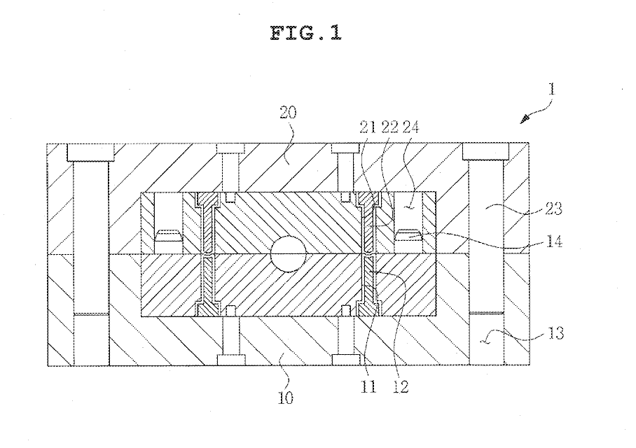

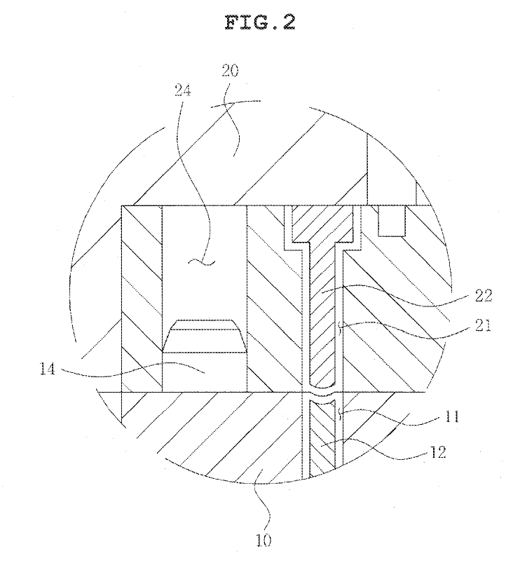

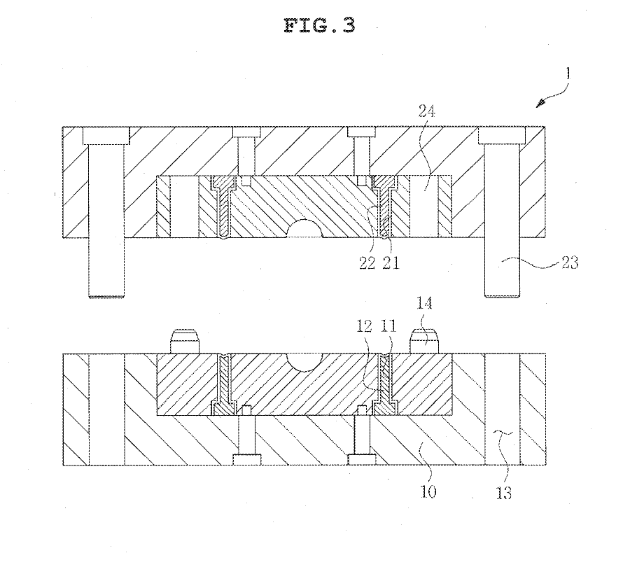

FIG. 1 is a schematic diagram illustrating a mold for forming a lens, in accordance with an embodiment of the present invention. FIG. 2 is a schematic diagram illustrating a main part of the mold for forming a lens, in accordance with an embodiment of the present invention. FIG. 3 is a schematic diagram illustrating a state in which the first mold 10 and the second mold 20 are spaced apart from each other in the mold for forming a lens, in accordance with an embodiment of the present invention.

Referring to FIGS. 1 and 2, a mold 1 for forming a lens, according to an embodiment of the present invention, includes a first core 12, which is coupled with the first mold 10, and a second core 22, which is coupled with a second mold 20, to face the first core 12.

Hereinafter, the mold 1 for forming a lens according to an embodiment of the present invention will be described in more detail with reference to FIGS. 1 to 3.

Referring to FIGS. 1 to 3, the first core 12 is coupled with a first core hole 11 of the first mold 10.

Herein, the first mold 10 is provided with a plurality of first core holes 11 in a direction in which the first mold 10 faces the second mold 20 and the first core 12 is coupled with the first core hole 11.

In accordance with at least one embodiment, the first core 12 and the first core hole 11 are formed to face each other and an outer diameter of the first core 12 is formed to be smaller than that of the first core hole 11. In this case, the outer diameter of the first core 12 is formed to be 1 to 2 μm smaller than a diameter of the first core hole 11.

Further, according to an embodiment of the present invention, when an expansion of the first core 12 is ΔP₁ and an expansion of the first core hole 11 is ΔH₁, the following Conditional Equation (1) is satisfied.

2 μm<ΔP₁−ΔH₁ (1)

In accordance with at least one embodiment, an assembly is facilitated by satisfying the above Conditional Equation 1.

In the above Equation, for example, the expansion of the first core 12 according to an embodiment of the present invention is obtained from the following Equation 1.

ΔP₁=α₁×ΔT×P₁ [Equation 1]

ΔP₁: Expansion of first core 12

α₁: Coefficient of thermal expansion of first core 12

ΔT: Temperature

P₁: Diameter of first core 12

Further, in accordance with at least one embodiment, the first core 12 is made of a material having a coefficient of thermal expansion larger than that of the first mold 10. In this case, the first core 12 is made of a material having a coefficient of thermal expansion of 17×10⁻⁶ or more. Therefore, the first core 12 is thermally expanded at the time of forming the lens, and thus a gap between the first core 12 and the first core hole 11 is minimized.

Further, when the coefficient of thermal expansion of the first core 12 is α₁ and the coefficient of thermal expansion of the first mold 10 is β₁, the following Conditional Equation (2) is satisfied.

5×10⁻⁶<α₁−β₁<10×10⁻⁶ (2)

In accordance with at least one embodiment, when the first core 12 is made of a material having a larger value than the above Conditional Equation 2, the first core hole 11 is deformed, and when the first core 12 is made of a material having a smaller value than the above Conditional Equation 2, the assembling performance is poor.

Further, in accordance with at least one embodiment, the first core 12 is made of a material having heat conductivity of 50 W/m° C. or more. Therefore, a surface frozen layer is formed due to quick cooling of the lens which is a molding product, such that the occurrence of appearance defects, such as a flow mark, is remarkably reduced.

Meanwhile, the first core 12, according to various embodiments, is made of a moldmax material. Further, the first core 12 is formed, for example, by plating nickel (Ni) on an outer surface thereof.

In accordance with at least one embodiment, the second core 22 is coupled with a second core hole 21 of the second mold 20 to face the first core 12.

Herein, the second mold 20 is provided with a plurality of second core holes 21 in a direction in which the second mold 20 faces the first mold 10 and the second core 22 is coupled with the second core hole 21.

Further, in accordance with at least one embodiment, the second core 22 and the second core hole 21 are formed to face each other and an outer diameter of the second core 22 may be formed to be smaller than that of the second core hole 21. In this case, the outer diameter of the second core 22 is formed to be 1 to 2 μm smaller than a diameter of the second core hole 21.

Further, according to the embodiment of the present invention, when the expansion of the second core 22 is ΔP₂ and the expansion of the second core hole 21 is ΔH₂, the following Conditional Equation (3) is satisfied.

2 μm<ΔP₂−ΔH₂ (3)

The assembly may be facilitated by satisfying the above Conditional Equation 3.

In accordance with at least one embodiment, in the above Equation, for example, the expansion of the second core 22 according to the embodiment of the present invention is obtained from the following Equation 2.

ΔP₂=α₂×ΔT×P₂ [Equation 2]

ΔP₂: Expansion of second core 22

α₂: Coefficient of thermal expansion of second core 22

ΔT: Temperature

P₂: Diameter of second core 22

Further, in accordance with at least one embodiment, the second core 22 is made of a material having a coefficient of thermal expansion larger than that of the second mold 20. In this case, the second core 22 is made of a material having a coefficient of thermal expansion of 17×10⁻⁶ or more. Therefore, the second core 22 is thermally expanded at the time of forming the lens, and thus the gap between the second core 22 and the second core hole 21 is minimized.

Further, in accordance with at least one embodiment, when the coefficient of thermal expansion of the second core 22 is α₂ and the coefficient of thermal expansion of the second mold 20 is β₂, the following Conditional Equation (4) is satisfied.

5×10⁻⁶<α₂−β₂<10×10⁻⁶ (4)

When the second core 22 is made of a material having a larger value than the above Conditional Equation 4, the second core hole 21 is deformed and when the second core 22 is made of a material having a smaller value than the above Conditional Equation 4, the assembling performance is poor.

Further, the second core 22 is made of a material having the heat conductivity of 50 W/m° C. or more. Therefore, the surface frozen layer is formed due to the quick cooling of the lens which is the molding product, such that the occurrence of appearance defects such as a flow mark is remarkably reduced.

Further, the second core 22, according to various embodiments, is made of a moldmax material having a thermal transfer coefficient to keep a uniform temperature distribution, thereby improving the shape precision of the lens.

Further, in accordance with at least one embodiment, the second core 22 is formed by plating nickel (Ni) on an outer surface thereof.

Meanwhile, in the mold 1 for forming a lens according to the embodiment of the present invention, a guide hole 13 is formed in the first mold 10 and a guide post 23 moving along the guide hole 13 of the first mold 10 is formed in the second mold 20.

Further, in the mold 1 for forming a lens according to the embodiment of the present invention, a guide hole 24 is formed in the first mold 10 and a guide pin 14 moving along a guide of the guide hole 24 of the first mold 10 is formed in the second mold 20.

Therefore, at the time of the operation of forming a lens, the centers of the first core 12 of the first mold 10 and the second core 22 of the second mold 20 match each other.

The mold 1 for forming a lens according to the embodiment of the present invention as described above may minimize the occurrence of the gap between the first core 12 and the first core hole 11 and the gap between the second core 22 and the second core hole 21, thereby preventing the occurrence of the decenter that the centers of the first core 12 and the second core 22 mismatch each other.

Further, in the mold 1 for forming a lens according to the embodiment of the present invention, the first core 12 and the second core 22 are made of a material having high heat conductivity, such that the appearance defect of the lens molding product disposed between the first core 12 and the second core 22 is remarkably reduced at the time of forming the lens.

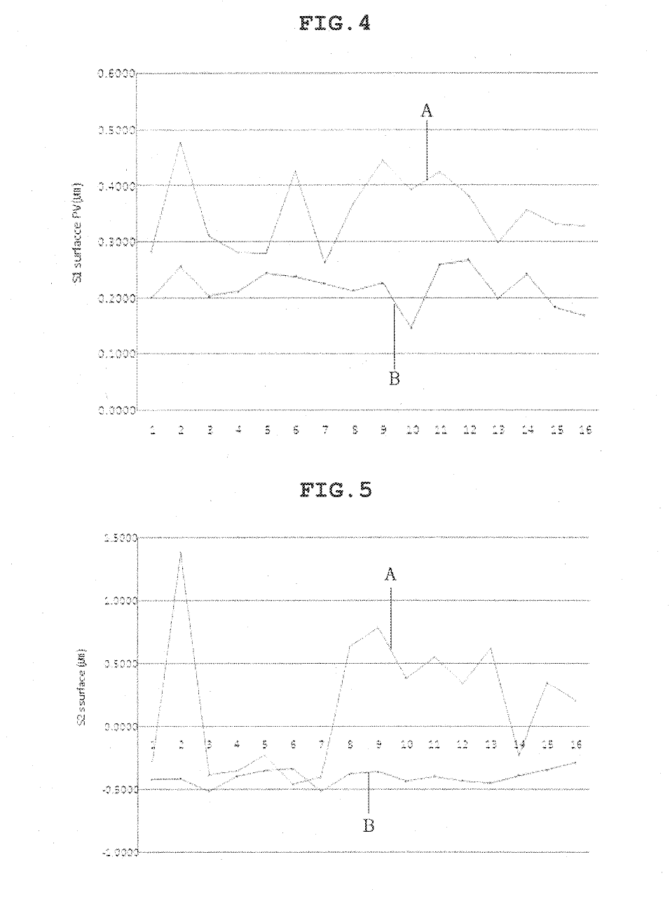

FIG. 4 is a graph illustrating an aspheric shape error of one surface of the lens formed in the mold for forming a lens, in accordance with an embodiment of the present invention, and the mold for forming a lens, in accordance with the conventional art. FIG. 5 is a graph illustrating an aspheric shape error of the other surface of the lens formed in the mold for forming a lens, in accordance with an embodiment of the present invention, and the mold for forming a lens, in accordance with the conventional art.

Herein, a vertical axis (Y axis) of FIG. 4 is a numerical value, which represents an aspheric shape error PV occurring in one surface S1 of the lens, and a vertical axis (Y axis) of FIG. 5 is a numerical value, which represents the aspheric shape error PV occurring in the other surface S2 of the lens. Further, the values represented on a horizontal axis (X axis) of FIGS. 4 and 5 are numbers allocated to each of the cavities, which is a space in which the lens is molded, in the mold for forming a lens.

Referring to FIG. 4, comparing the graph A representing the aspheric shape error PV of the one surface S1 of the lens molded in the mold for forming a lens according to the related art with the graph B representing the aspheric shape error PV of the one surface S1 of the lens molded in the mold for forming a lens according to the embodiment of the present invention, it may be appreciated that the aspheric shape error PV of the one surface S1 of the lens molded in the mold for forming a lens according to the embodiment of the present invention is more remarkably reduced than the aspheric shape error PV of the one surface S1 of the lens molded in the mold for forming a lens according to the conventional art.

Referring to FIG. 5, comparing the graph A representing the aspheric shape error PV of the other surface S2 of the lens molded in the mold for forming a lens according to the related art with the graph B representing the aspheric shape error PV of the other surface S2 of the lens molded in the mold for forming a lens according to the embodiment of the present invention, it may be appreciated that the aspheric shape error PV of the other surface S2 of the lens molded in the mold for forming a lens according to the embodiment of the present invention is more remarkably reduced than the aspheric shape error PV of the other surface S2 of the lens molded in the mold for forming a lens according to the conventional art.

According to preferred embodiments of the present invention, it is possible to prevent defects from occurring at the time of molding the lens by preventing the occurrence of the decenter that the center between the mutually facing cores of the mold is mismatched.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A mold for forming a lens, the mold comprising:
a first core coupled with a first core hole of a first mold; and
a second core coupled with a second core hole of a second mold to face the first core,
wherein the first core and the second core are each made of a material having a coefficient of thermal expansion larger than that of the first mold and the second mold, and
wherein outer diameters of the first core and the second core are each formed to be smaller than diameters of the first core hole and the second core hole.

2. The mold as set forth in claim 1, wherein the outer diameters of the first core and the second core are each formed to be 1 to 2 μm smaller than diameters of the first core hole and the second core hole.

3. The mold as set forth in claim 1, wherein, when an expansion of the first core is ΔP₁ and an expansion of the first core hole is ΔH₁, a conditional equation of 2 μm<ΔP₁−ΔH₁ is satisfied.

4. The mold as set forth in claim 1, wherein, when an expansion of the second core is ΔP₂ and an expansion of the second core hole is ΔH₂, a conditional equation of 2 μm<ΔP₂−ΔH₂ is satisfied.

5. The mold as set forth in claim 1, wherein the first core or the second core is made of a material having a coefficient of thermal expansion of 17×10⁻⁶ or more.

6. The mold as set forth in claim 1, wherein, when the coefficient of thermal expansion of the first core is α₁ and the coefficient of thermal expansion of the first mold is β₁, a conditional equation of 5×10⁻⁶<α₁−β₁<10×10⁻⁶ is satisfied.

7. The mold as set forth in claim 1, wherein, when the coefficient of thermal expansion of the second core is α₂ and the coefficient of thermal expansion of the second mold is β₂, a conditional equation of 5×10⁻⁶<α₂−β₂<10×10⁻⁶ is satisfied.

8. The mold as set forth in claim 1, wherein the first core and the second core are made of a material having heat conductivity of 50 W/m ° C. or more.

9. The mold as set forth in claim 1, wherein the first core and the second core are made of a moldmax material.

10. The mold as set forth in claim 1, wherein outer surfaces of the first core and the second core are plated with nickel (Ni).

11. A mold for forming a lens, the mold comprising:
a first mold formed with a first core hole;
a second mold disposed in a direction in which the second mold faces the first mold and formed with a second core hole;
a first core coupled with the first core hole of the first mold; and
a second core coupled with the second core hole of the second mold to face the first core,
wherein the first core and the second core are made of a material having heat conductivity of 50 W/m ° C. or more.

12. The mold as set forth in claim 11, wherein the first core and the second core are each made of a material having a coefficient of thermal expansion larger than that of the first mold and the second mold, and
an outer diameter of the first core and the second core is formed to be smaller than a diameter of the first core hole and the second core hole.

13. The mold as set forth in claim 12, wherein the outer diameters of the first core and the second core are each formed to be 1 to 2 μm smaller than diameters of the first core hole and the second core hole.

14. The mold as set forth in claim 11, wherein, when an expansion of the first core is ΔP₁ and an expansion of the first core hole is ΔH₁, a conditional equation of 2 μm<ΔP₁−ΔH₁ is satisfied.

15. The mold as set forth in claim 11, wherein, when an expansion of the second core is ΔP₂ and an expansion of the second core hole is ΔH₂, a conditional equation of 2 μm<ΔP₂−ΔH₂ is satisfied.

16. The mold as set forth in claim 11, wherein the first core and the second core are made of a material having a coefficient of thermal expansion of 17×10⁻⁶ or more.

17. The mold as set forth in claim 11, wherein, when the coefficient of thermal expansion of the first core is α₁ and the coefficient of thermal expansion of the first mold is β₁, a conditional equation of 5×10⁻⁶<α₁−β₁<10−10⁻⁶ is satisfied.

18. The mold as set forth in claim 11, wherein when the coefficient of thermal expansion of the second core is α₂ and the coefficient of thermal expansion of the second mold is β₂, a conditional equation of 5×10⁻⁶<α₂−β₂<10×10⁻⁶ is satisfied.

19. The mold as set forth in claim 11, wherein the first core and the second core are made of a moldmax material.

20. The mold as set forth in claim 11, wherein outer surfaces of the first core and the second core are plated with nickel (Ni).
